(19) United States
(12) Patent Application Publication
(10) Pub. No.: US 2017/0123450 A1
(43) Pub. Date: May 4, 2017

(54) INTERACTIVE DISPLAY DEVICE

(71) Applicant: Alan Mittelman, Calabasas, CA (US)

(72) Inventor: Alan Mittelman, Calabasas, CA (US)

(21) Appl. No.: 15/338,036

(22) Filed: Oct. 28, 2016

Related U.S. Application Data
(60) Provisional application No. 62/248,095, filed on Oct. 29, 2015.

(51) Int. Cl. G06F 1/16; G09G 5/00; G09G 5/39; G06F 3/14; G06F 1/32; G06F 3/16

(52) U.S. Cl. CPC G06F 1/1601; G06F 1/1605; G06F 1/3206; G06F 3/165; G09G 5/39; G06F 3/14; G09G 5/006; G09G 2370/022; G09G 2370/16; G09G 2330/026; G09G 2330/022; G09G 2354/00; G06F 3/0488

(57) ABSTRACT

An interactive display device comprises a housing containing at least one compartment for accommodating a product. Information elating to the product is stored on the device itself, or remotely but with a wireless connection. A display device is associated with the housing, and the display device selectively displays the information relating to the product within the housing. A power source is provided for the interactive display device.

### CROSS-REFERENCE TO RELATED APPLICATIONS

This application claims the benefit of U.S. Provisional Patent Application No. 62/248,095 filed Oct. 29, 2015, the contents of which are incorporated by reference in their entirety.

### FIELD AND BACKGROUND OF THE INVENTION

This invention relates to a display device. The display device may be interactive in nature, and may have the ability to store information and present such information to a potential consumer relating to items or products which may be contained or associated with the display device.

Display devices for products are common and well known, and may typically comprise a container of some sort, as well as compartments, or shelves or other platforms to receive products. Such display devices may include lighting to make the products appear more attractive, and may have other characteristics, such as, for example, the ability to rotate, orient in different manners, and the like. Such display devices may also be modular in construction so that they can be adapted to receive different products, replaced as necessary, of varying sizes and dimensions, at different times according to the preferences of the user, and depending upon special offers or promotions which may be currently in effect.

### SUMMARY OF THE INVENTION

According to one aspect of the invention, there is provided an interactive display device comprising: a housing containing at least one compartment for accommodating a product; information electronically stored relating to the product; an electronic display device associated with the housing, the display device selectively displaying the information relating to the product within the housing; and a power source.

According to another aspect of the present invention, there is provided a display device which is preferably interactive, and which may contain or have access to stored information relating to products which may be exhibited or contained within the display device. Moreover, the stored information is preferably changeable and can be updated, depending upon the nature of the products contained within the display device.

In one form of the invention, the display device may have a plurality of different shelves, platforms, cubbyholes or other designated areas which may be specially adapted to accommodate products or items of different sizes and shapes. The display device is preferably capable of dispensing information relating to a selected product or item which may be contained therein, as chosen by a potential consumer. However, may also be used independently without these specific adaptations.

The information relating to a product or item contained within the display container may be in the form of a written, video or graphic presentation on a suitable monitor which forms part of the display device, or it may be in the form of spoken information through a speaker also associated with the display device. It is also within the scope of the invention that the information may be presented to a consumer both visually and audibly in an effort to more effectively capture the attention and focus of a consumer.

In another form, the display device of the invention may be connectable to a remote device, such as a mobile phone or a tablet, so that a user or consumer is able to select a product and information relating thereto in the display device and receive audio, visual, or a combination thereof, of information on how remote device. Such information may be transmitted from the display device, or other source, but Wi-Fi, Bluetooth, or other selected manner.

In one form of the invention, the display device may comprise or have associated therewith a sensor for sensing whether a person is within a given range of the display device. Preferably, the sensor is one which senses motion, but the invention is not limited thereto. The sensor may be coupled to the stored information, or be programmed separately, so that presentation of visible or audible information initiates when a person who is in the vicinity of the display device can be detected by the sensor. In this regard, the display device may emanate an audible sound to capture the attention of a person in the vicinity, or it may provide information about a randomly selected product or item which is contained within the display device.

In one form of the invention, the display device comprises a cabinet which may be formed of a base, walls and/or various partitions, some or all of which may be transparent so that products contained within the display device can be seen from different observation points. The display device may comprise compartments or sectioned off areas, each of which may be adapted to receive a different product or item being offered for sale. Further, the invention in one aspect provides that each of the compartments may be individually illuminated, so that an item in the display case selected by a potential consumer, in a manner to be described below, may be appropriately illuminated while other items are not. This may assist in focusing the consumer on the item selected, and being provided with information related to that particular item.

The display case may further comprise a mechanism whereby a potential consumer can request specific information regarding an item contained within the display device. In this regard, the display device may comprise one or more activators, each activator associated with a product in the display device, and triggering the display of information relating to such product when activated. The activators themselves may be in the form of physical buttons or switches, each associated with a specific area or portion of the display device, or they may be in the form of a touch sensitive surface which can be touched by the potential consumer to cause the activation. The activator may be associated and contiguous the particular section or area of the display device to which it relates, or various areas in the display device may be numbered or have some other form of identity and be associated with buttons or a touch sensitive surface for the use of a consumer, so that the consumer can select an item accordingly.

An important and beneficial feature of the present invention relates to the storage of information concerning products and items in the interactive display. The information may be stored in many different formats and media, and may comprise hardware associated with the interactive display, or wireless connections through Bluetooth, Wi-Fi routers or other electronic devices. The information may be received by the interactive display device from a hardwired connection or a wireless connection, and it may in fact be capable of transmitting information to another source or device. Thus, a potential consumer may, in one aspect of the invention, obtain information transmitted from the interactive device so that it is received on the consumers smart phone, tablet, or sent to an email address, as preferred by the consumer.

Hard wired connections to the interactive display device may be in the form of portable hard drives, thumb or flash drives, CDs, DVDs or any other media. The invention is not to be construed as in any way limited to information storage devices of any particular type or configuration. Such drives may be connected directly into an appropriate portion of the display device, or it may be connectable to a control box or other device associated or connected to the interactive display.

As mentioned above, the display device may also be configured so as to receive wireless signals from a remote source, so that information from the remote source is transmitted to the display device on an as needed basis, such as for example to reflect any audio or video changes, when requested by a consumer, a merchant or other appropriate entity. The interactive display device of the invention may also be configured so as to provide information regarding similar products to the one(s) identified by a user, or even related products which may be of interest to the user.

The information and information storage of the interactive display device of the invention is noteworthy for its flexibility. In this regard, display devices for containing consumer products and items may regularly be changed, so that one product is replaced with a another, and the present invention allows for simple and easy selection of information so that the product in the display device and the information details relating thereto can be easily matched.

The display device may also have many different types of sensors associated with each product in the display device. Therefore, in this aspect of the invention, a consumer or person interested in a product within the display case may, for example, points towards that specific product. The position of the pointing finger can be detected and associated with the appropriate product, so that the person may receive the information relating to the product. These types of sensors may be motion detectors which detect the presence of a finger or other object near the product, or they may be light sensitive or activated whereby the position of a person's finger or other object would break a beam of light and trigger the consequential activation of information to be provided relating to the product which has been selected.

Other types of sensors or detectors may also be used, additionally or in combination, and the invention is not limited to those which are described herein.

The same or additional sensors may detect the presence of a person from distances which may be varied and are selectable by programming. Therefore, the display device may have sensors which detect the presence of a person, for example, up to 20 feet away and trigger some effect in an effort to secure the attention of the person. These types of sensors may be directional in nature so as to be operative only over certain areas around the display case, and do not activate more randomly when the presence of a person has been sensed. Sensing the presence of a person at a distance from the display device may result in a recorded call to the person, such as “Hi”, or “come on over”, or any such term considered appropriate to get the attention of people who may be in the vicinity of the display case.

The information and information systems stored in or in association with the display case may have different levels of detail. Therefore, an initial description of a particular product may be more general in nature. If an interested party wishes to hear or see more, she may be able to prompt the display device with words such as “more”, with a defined movement, or by activating a sensor, so that more detailed information is provided. The information may be on a tablet, with a touchscreen user interface, and the material displayed on the touchscreen may offer different categories of information which can be selected by the user, so that the information provided is tailored to the requirements and preferences of the person seeking information. As mentioned, the user may in one aspect of the invention be able to download such information to a tablet, smart phone or other device, or even receive a print out or email of all or specifically selected information for later review and consideration. Furthermore, information may be provided in several languages, and one of these may be selected by the consumer.

It will be appreciated that the information relating to a product can be easily removed if the product itself is removed from the display case. Further, the information can be supplemented, amended, corrected, making it extremely versatile and easy to not only describe products which may be placed in the interactive display device, but also change the information based on experiences. It may, therefore, be found from questions by potential consumers that certain pieces of information would be useful to provide, but are not actually included at the present time. This can be readily accomplished by creating text, graphics, video or other additional material to rectify what may be an initial omission.

In a retail setting, information may be prepared by the manufacturer of the product. The information may be transmitted to the retailer so that it can be associated with the display device. This would allow the retailer to utilize such pre-prepared information, a useful feature especially where the retailer sells a large number of different types of products, and may not have the time or necessary technical expertise to create information relating to all of the products which it sells. Information from the manufacturer may thus be sent to the point of sale on hardware such as a thumb drive, SD card, portable drive or the like, or it may be transmitted wirelessly or over the Internet and thereafter downloaded by the retailer and associated with the interactive display device in the appropriate manner.

### BRIEF DESCRIPTION OF THE DRAWINGS

FIG. 1 is a schematic representation showing different parts and components for use with an interactive display device in accordance with the invention; and

FIG. 2 is one of many types of display cases which may be used with the electronic features in accordance with the present invention; and

FIG. 3 is a schematic representation of a interactive display device in accordance with a further aspect of the invention showing a display case, and lighting and video for insertion therein;

FIGS. 4A, 4B, 4C and 4D show various views of an embodiment of the invention similar to that illustrated in FIG. 3 of the drawings; and

FIGS. 5A and 5B show front and rear views of a video display in accordance with one aspect of the invention.

### DETAILED DESCRIPTION OF THE INVENTION

Reference is now made to the drawings which shows various embodiments and features of the present invention. The drawings are intended to exemplify the invention, to show some of its applications and potentials, but should not be considered to limit the invention to these particular embodiments.

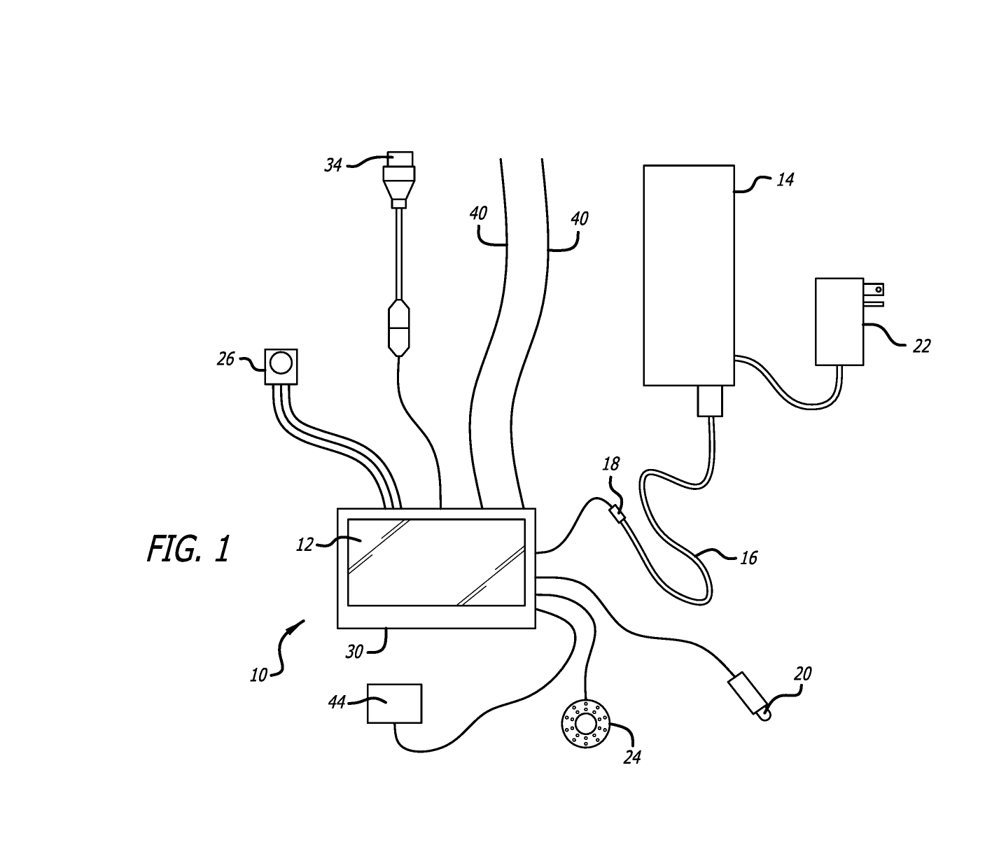

FIG. 1 of the drawings shows selected electronic components and devices which may be used in the construction and configuration of an interactive display device in accordance with just one aspect of the invention. The system 10 includes a control box 12, which is central to and controls and unifies the various components which may be attached thereto. The system 10 is powered by a battery 14 which in one embodiment may be a portable and rechargeable battery. The battery 14 may either be removed from the system when depleted, and easily replaced with another, or recharged without being removed. Alternating batteries 14 allows the system to continue operating essentially without break, with one battery being connected while another is being charged. Any number of batteries may be used. The battery 14 is connected by cables 16 through a power supply port 18 to the control box 12. The video display unit may be one which does not require an 110/220 V electrical source or outlet to operate. Rather, the display may play in any location by way of one or more charger batteries, as an example, secured to or associated with the display.

A power switch 20 is provided so as to selectively activate and deactivate the control box 12.

A power adapter 22 may be provided, and a USB cable may connect the power adapter 22 and the control box 12 to provide a continuous source of power. The system 10 may be powered, therefore, by replaceable and rechargeable batteries, or through a continuous AC connection including a power adapter, so that a 110 to 220 V electric supply may be used without damaging or overloading the system with power.

A speaker 24 is provided, and audio material, such as talk, music and sound effects, are played through the speaker 24, according to the prepared and recorded information relating to a specified product. A speaker volume control 26 may also be provided to adjust sound volume. Headphones may also be used in accordance with a further aspect of the invention.

The control box 12 includes a monitor or screen 30, which plays video, as programmed for a selected product. The data or files containing such video may be stored within the control box 12 itself, or they may be in an attachable and removable medium, such as a portable hard drive, SD card, flash drive or the like. In any event, a USB port connector 34 is provided so that video and other files may be played and displayed, or updated, on the monitor 30 and through the speaker 24. The USB port connector 34 will allow the data to either be transferred and loaded onto a hard drive in the control box 12 directly so as to be stored in the control box 12, or it provides a means of connection to one or more media containing such files so that the video and audio material can be displayed on the monitor 30 and broadcast on the speaker 24 directly from the portable medium without first being loaded onto a hard drive in the control box 12.

The system 10 may also include LED lighting, with cables or wiring 40 connected to the control box 12 so that products can be randomly or selectively illuminated based on information which is being provided by the system through the display 30 and speaker 24. A plurality of lighting may be provided, so that portions or sections of the display device, to be described below, can be selectively illuminated to light up a specific product or item in the display device which matches the information being provided through the monitor 30 and or speaker 24.

The system 10 may further comprise an infrared (IR) or other sensor. The sensor is connected to the control box 12, and there may be several sensors in a particular system each of which may be designed to detect different conditions. The sensors may be motion sensors, IR sensors, light sensors, or any other type of sensor, since the invention is not to be limited in this regard.

The IR sensor 44 may be programmed to detect the presence of a person within the vicinity of the display device. The nature of the IR sensor 44 may be tailored so as to activate the system when a person or consumer is within a specified range, which can be programmed according to specific needs. In some contexts, the IR sensor may detect the presence of a person as much as 20 feet or more away in order to activate the system, while in other contexts, activation may not occur until the person is much closer. The triggering of the system 10 by the sensor 44 will, therefore, clearly depend upon the nature of the intended marketing program, the products, as well as the specific location and the ambient surroundings.

The control device 12 would typically be placed within, on, or adjacent an interactive display so that it can be observed by a person in conjunction with a product contained within the display device. In one preferred form of the invention, the display device may have a compartment or section, with a transparent cover if appropriate, for containing the control box in a manner such that the monitor 30 is in a convenient and easily observable position. Further, the display device may have at least one compartment or section, which may be concealed and not open to view, for accommodating the electronic components and cables so these do not constitute unsightly distractions for the user.

In the description above, the control box 12 is one which includes the monitor 30. However, it is definitely within the scope of the invention that these two components be separate. Thus, a display device in the form of a monitor or screen may be provided, and may be connected to a control box within the system in much the same way as the other components, such as sensors, switches and speakers, are connected thereto.

It will also be appreciated that FIG. 1 of the drawings shows certain selected electronic components, but the system may in fact have additional components. For example, specific input from individual areas or compartments in the display case may each have sensors, as well as individual customized lighting, and these may be activated from sensors which are placed at the appropriate section so that the necessary information may be provided, and illumination effected, for that area.

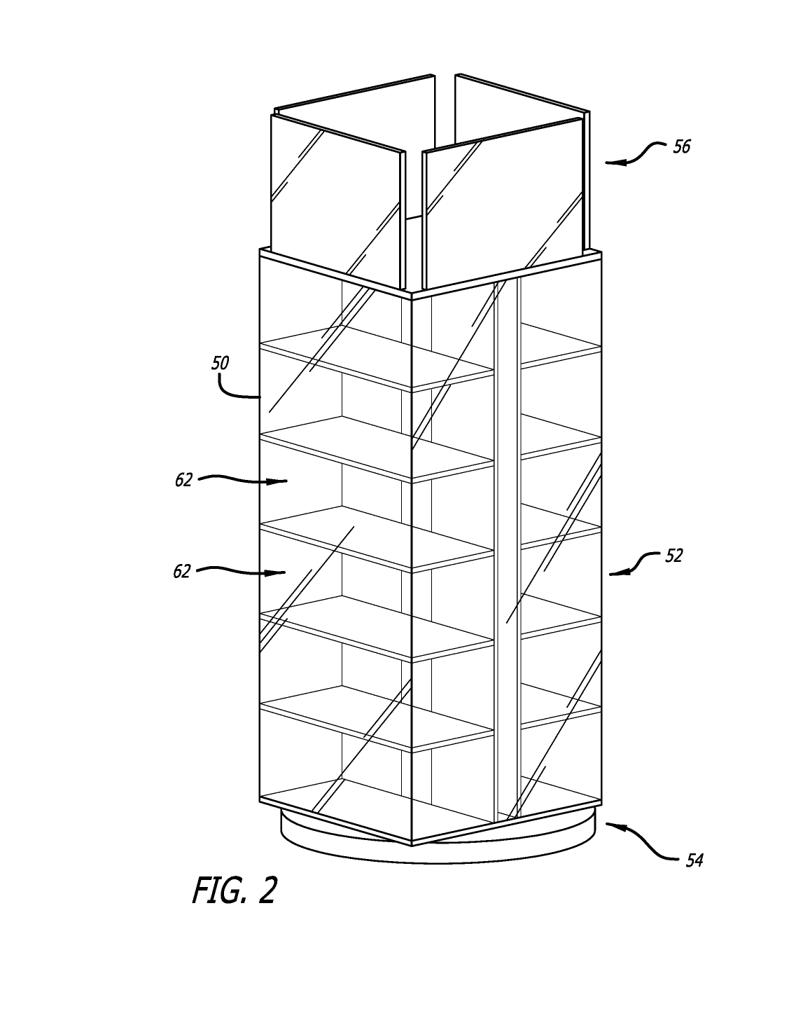

FIG. 2 of the drawings shows a display case which may be used in one aspect of the present invention. It must, of course, be appreciated that display devices and cases may come in a myriad of different configurations, sizes, and styles, and the display device 50 is therefore exemplary only, and not intended to limit or restrict the invention to this particular style or configuration.

The display device 50 includes a display section 52 a base 54 and a top section 56. The display section 52 may be mounted on the base 54 so that it can be selectively rotated for the convenience of the viewer so that any of the sides of the display section 52 can be easily viewed. Another option is to have the product display freely spin 360 degrees while the video player remains stationary for viewing control. A center shaft within the display may be provided, and will support the video player and remain independent of the product display.

It will be seen that the display section 52 has a number of vertically stacked sections 60, 62 etc., and each of these sections is designed to accommodate one or more products or items. Each section may have its own sensor for sensing the touch, pointing, or physical presence of a finger or other object so that information relating to the product in that specific section may be displayed on the monitor and described audibly through the speaker 24. Further, another sensor, or through the operation of the control box, may result in illumination of the selected section so that the product therein may be lighted to the exclusion of other products in the display case. The display device therefore includes customized lighting which may be recessed or hidden, preferably LED to conserve power, and may include buttons or switches or the like which may be touched or moved by a user, or may be sensitive to the presence of the user, to trigger operation with respect to a selected product.

The control box 12 may be programmed to illuminate, show video and describe other products in the display case which may be related and possibly of interest to a consumer, providing other choices.

The top section 56 of the display case 50 may have slots or one or more sections for accommodating cards or other media including electronic media, to enhance the marketing potential of the device and its contents, and to attract the attention of passers by. These cards, posters or other types of media may be easily replaceable, or rotatable, so as to have maximum impact, and to remain relevant to the products in the display device, as well as the information which is relayed through the speaker and monitor, as described above.

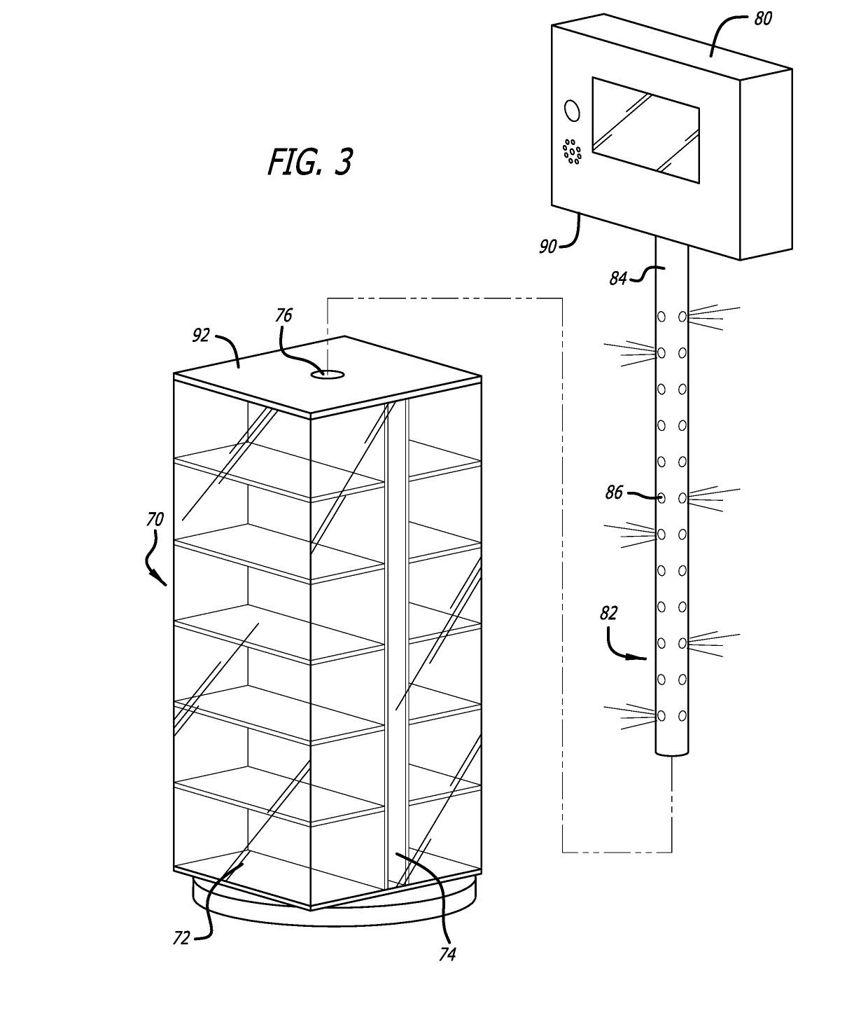

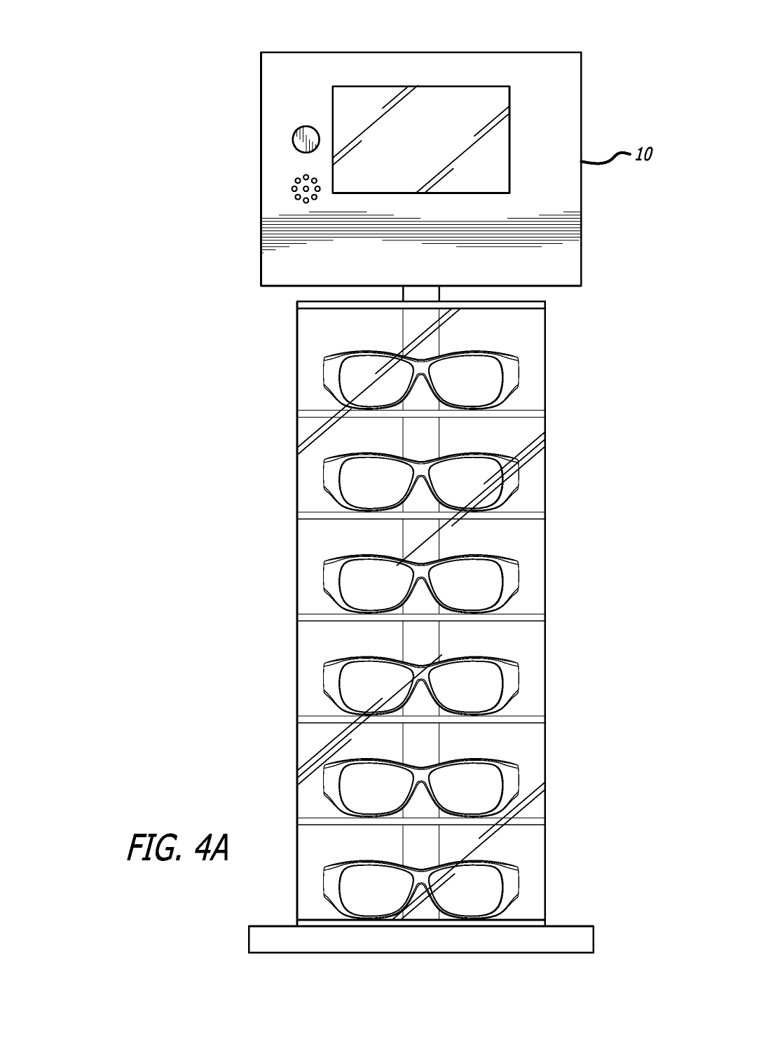

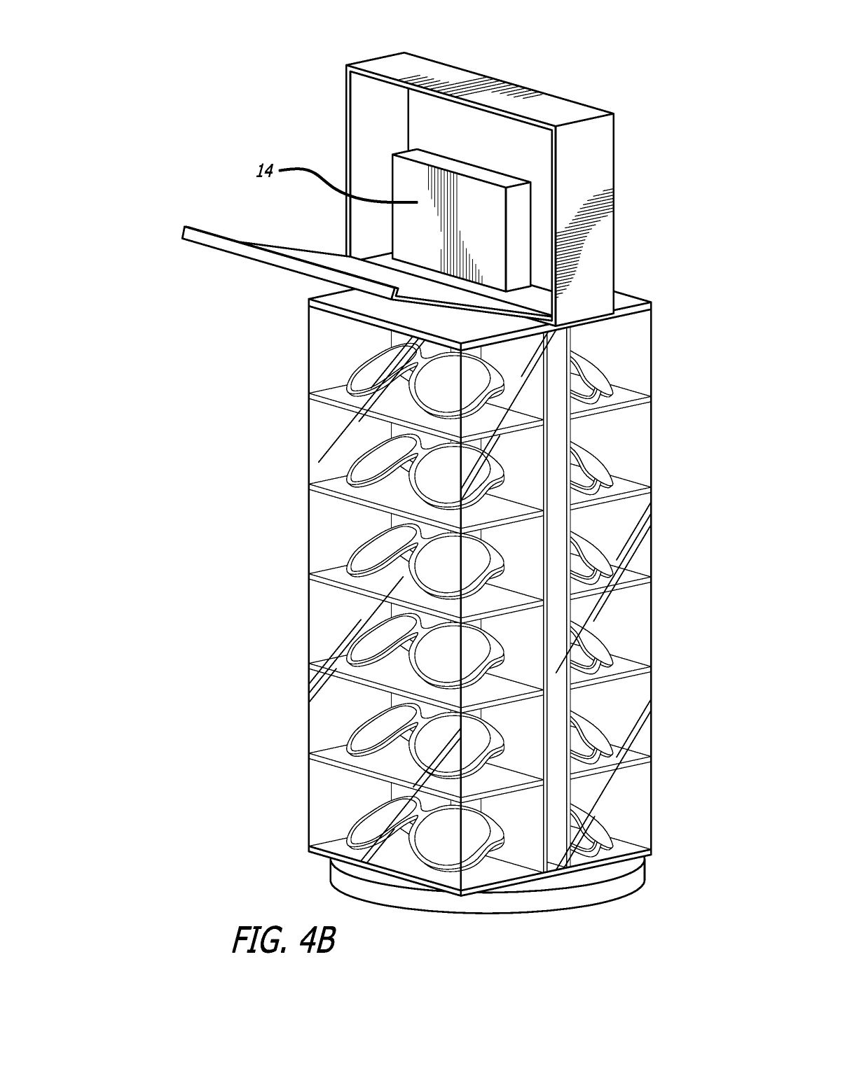

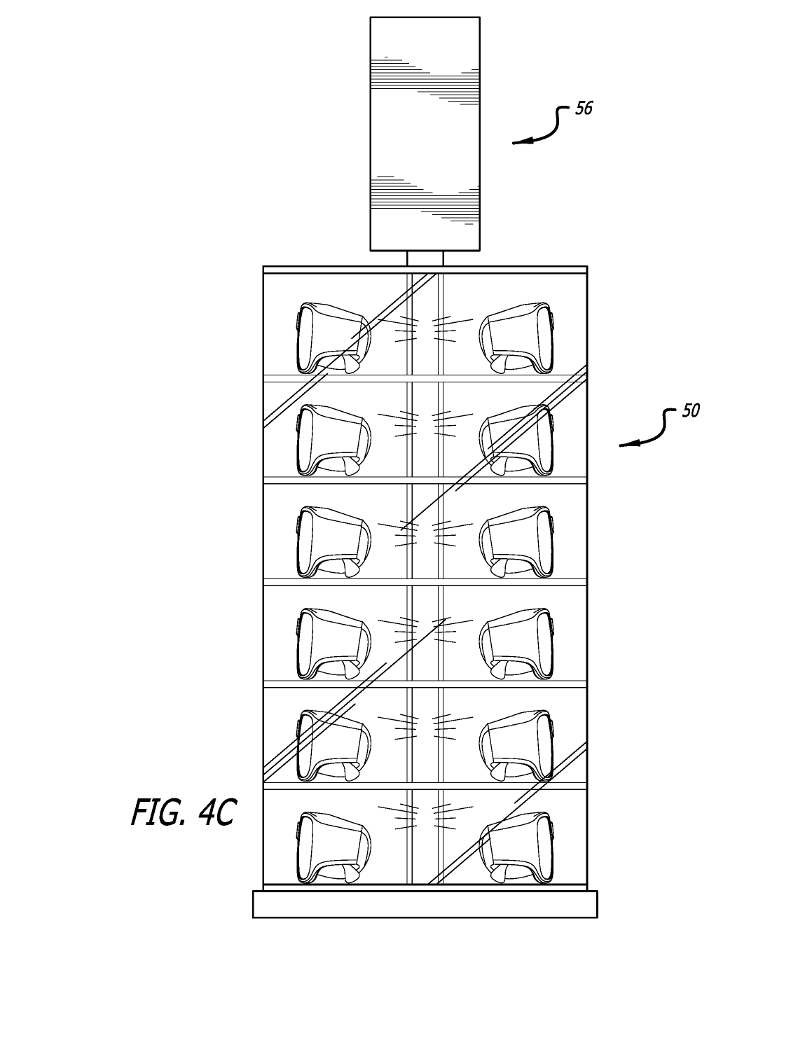

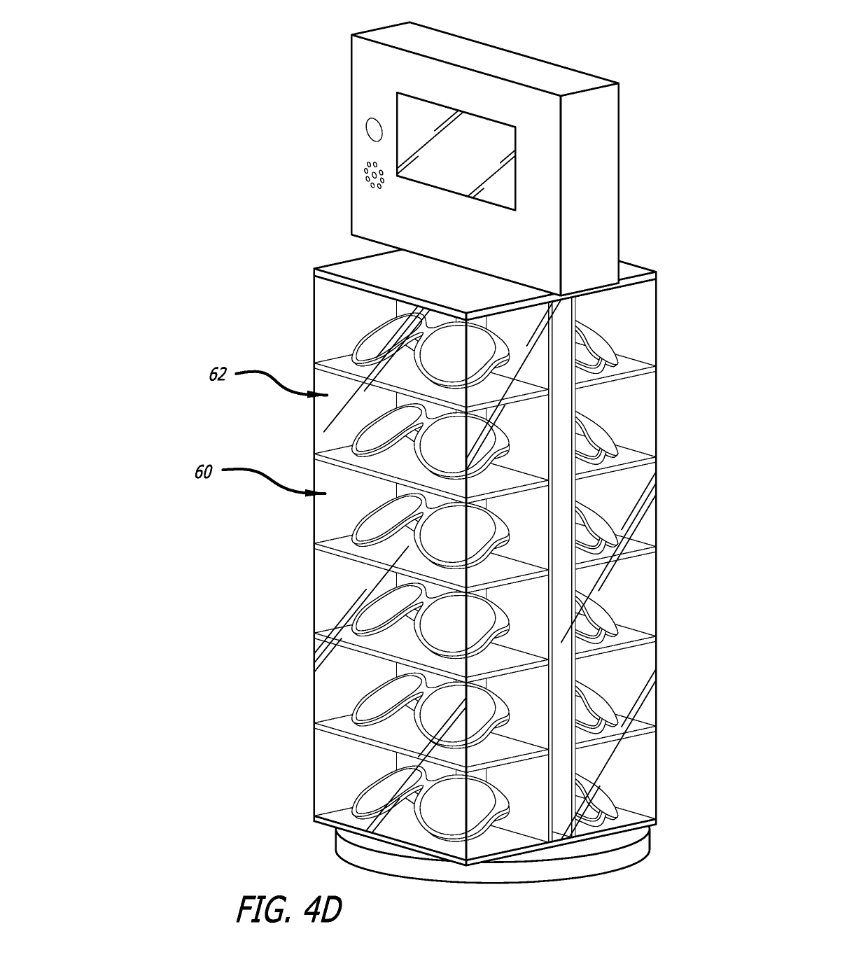

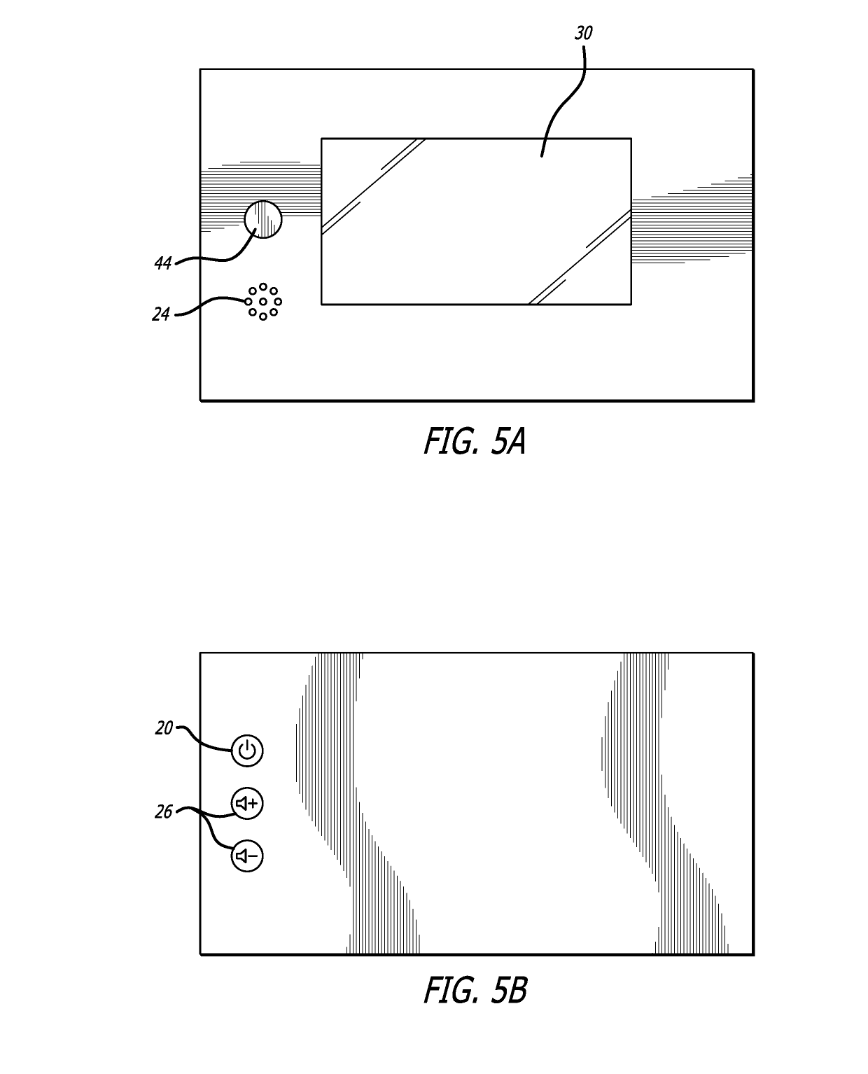

Reference is now made to FIG. 3 of the drawings, which shows a further embodiment of an interactive display device in accordance with the invention. FIG. 3 illustrates a display device 70 having a series of vertical compartments 72, although other design configurations for such compartments are well within the scope of the present invention. Each compartment 72 is configured so as to receive a product, which can be changed at will. It will be noted that the series of vertical compartments 72 are positioned on each side of a central vertical space 74. The display device 70 is preferably comprised of at least in part a translucent material so that the compartments 72 can be illuminated from a light source outside of the compartment. The central vertical space 74 has at its upper end and opening 76, in communication with the central vertical space 74.

A video display 80 is provided, and is mounted on a lighting shaft 82 which supports it. The lighting shaft 82 comprises a post 84 upon which a plurality of lights 86, preferably LED lights, are mounted, extending from near the top of the post 84 to near the bottom thereof. In use, the lighting shaft 82 is mounted on or connected to the display device 70 through the opening 76. When fully mounted, the shaft 82 will be accommodated substantially within the central vertical space 74, and the underside 90 of the video display 80 will rest on the upper surface 92 of the display device 70. When illuminated, the plurality of lights 86 will provide light to the various compartments 72. In one form, all of the lights 86 may be switched on at the same time so as to illuminate all of the various compartments 72, or the lights may be selectively illuminated to only light up one or more selected compartments 72.

As mentioned above, at least a part of the display device 70 is comprised of a translucent material so that lights 86 mounted on the post 84 provide lighting for all of the compartments 72. Generally, the post 84 is preferably of circular cross-section, and may be rotatable within the opening, and within the central vertical space 74. Therefore, a consumer may rotate the video display 80 so as to face her, for an enhanced viewing experience. The video display 80 may also be rotated to a desired position by the retailer or installer. Further, the video display 80 may be operable by a motor so that it can be rotated thereby, including in response to external sensors.

Of course, the material displayed and the sounds which emanate from the video display 80 can be selectively matched so as to provide information relating to a product accommodated in a selected compartment 72 of the display device 70. Further, all of the features of the invention as discussed herein, such as the storage of information and graphics, the transferring of such information to the video display, the sensing capabilities, and other characteristics of the invention, would be available for incorporation into the embodiment illustrated in this figure of the drawings.

In many devices operated by a battery, the battery may automatically shut down if the device to which it is providing power is not used for a particular period of time. This may be as little as a few seconds, to several minutes. The purpose of such a built in feature is to conserve battery power, so that the device will not drain the battery when it is not being used. In one embodiment of the invention, the various sensors, such as an IR sensor, that do not detect any human presence or movement near the device after a set period may automatically shift the device into a sleeping mode, wherein the video player, or the LCD screen, will shut down. In this sleeping mode, the video player and device generally consumes very little power from the external battery source. The power consumed in this situation may be as little as 0.0005% of the power consumption which the video player utilizes when working normally. However, the battery is always turned on until it is completely depleted, as long as the video player and device is connected to the battery.

One potential problem which may arise when the power utilization enters the sleeping mode is that the sensors for activating and operating the device may not respond to movement, light or other external conditions. Therefore, if the device is in the sleeping mode, and a person walks by, the sensors may not respond to the presence of the person, and the device will not be activated. Therefore, in accordance with one aspect of the invention, the system is set such that the amount of power consumption is never allowed to reach a point where the sleeping mode kicks in, and potentially disables the sensors. However, power consumption is held at the threshold, or just above the threshold, so that the system remains operational and receptive to movement or other stimuli by its sensors. In this way, power consumption can be substantially minimize to conserve the battery, but without dropping to a point which inactivates the system. This results in a win-win situation, whereby power consumption is held to a minimum, but the device remains operational and responsive to external stimuli. Of course, the amount of power needed to maintain the display device of the invention at the desired levels will depend upon various parameters, including the strength and charge of the batteries, and the requirements of the system. Taking these factors into account, power consumption after a given period of non-use will be set so as not to drop below the minimum requirements for keeping the system awake so as to respond to sensor stimuli. Various mechanisms and electronics can be used to achieve this purpose to prevent shutdown and retain minimal power to keep the system operational. For example, the system may incorporate resistors, or may otherwise emulate the equivalent of a stimulus to the sensors so that the system will recognize this and prevent any transfer into a sleep mode condition. This is, of course, just one possibility, and the invention is not limited by any specific circuitry or mechanisms which may be used to achieve this purpose.

In one embodiment of the invention, the video display system can be powered by two alternative power supply options: first, a portable rechargeable battery, and, second, a direct 110˜220 v electric supply with the power adaptor. The portable rechargeable battery features dual USB outputs, for example: 1 A: 1.5 v and 2 A: 2.5 v with 20,000 mAh capacity to store the power for multiple days of operation. The power can be controlled with an On/Off switch or button, and a power gauge may be provided to indicate the battery charge level. Inside the control box which is preferably double locked, the power source will be connected to two components: first, the video display system, and, second, the LED lighting or lighting strip. Both channels work separately from each other and can be adjusted by a user.

The video display system has, in one embodiment, a 5″ screen which displays in 16:9 ratio, has a frame resolution of 480×272 pixels, and a 25˜30 frame rate per second. The built-in memory storage can store up to 256 MB, or more. In terms of file supports, the system may operate under AVI video format, with an MPEG layer-3 as audio format. The built-in speaker has approximately a 30 millimeter round shape with the internal magnet at 8 2 W resistance. In terms of the electric operation, the system may require approximately 200 mAh in stand-by mode, and approximately 600˜650 mAh for each video play.

According to one aspect of the invention, there is therefore provided an interactive display device comprising: a display device having sections for accommodating one or more products; and a control center for receiving and presenting information relating to a selected product contained within the display device, the control center being connectable to a medium whereby information relating to a product is stored. The medium containing the information may be connected to the control center through wired cables, or may be connected wirelessly.

Preferably, the display device may be such that different products can readily be removed and replaced within one or more sections in the display device, and information relating to products currently contained within the display device can be easily associated with or downloaded to the control center.

In one aspect of the invention, the control device activates video and audio informational material for a selected product within the display case, according to the preferences of the user. The informational material may be contained in electronic files which can easily be loaded into the system and programmed so that the match is created between a product and informational material relevant thereto. Therefore, in accordance with the invention, there is further provided a video screen or monitor, and speakers, by means of which graphics, description and operation of a product is presented to a viewer.

In one aspect of the invention, there is also provided a power source, which may be in the form of an AC connection through a power adapter, or by means of a portable and rechargeable battery. In another aspect, a solar panel may be used to collect energy from overhead or room lighting and delivered to an internal storage battery. Further, the device may comprised lighting, the ability to move or rotate to product to offer different views, and such other features that may be considered beneficial.

According to another aspect of the invention, there is provided a method of displaying one or more products, the method comprising placing the products in a designated section of a display device, and providing various levels of information regarding the product in the display device when selected by a viewer.

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

1. An interactive display device comprising:
a housing containing at least one compartment for accommodating a product;
information electronically stored relating to the product;
an electronic display device associated with the housing, the display device selectively displaying the information relating to the product within the housing; and
a power source.

2. An interactive display device as claimed in claim 1 wherein the housing is comprised of at least partially translucent material.

3. An interactive display device as claimed in claim 1 further comprising illumination means for selectively illuminating one or more compartments of the housing.

4. An interactive display device as claimed in claim 1 further comprising sensors for activating the display device when an external condition is detected.

5. An interactive display device as claimed in claim 4 wherein the sensors are selected from one or more of: motion sensors, light sensors, IR sensors, heat sensors, and touch sensitive sensors.

6. An interactive display device as claimed in claim 1 further comprising physical activators for activating the display device.

7. An interactive display device as claimed in claim 1 wherein the information is stored on a memory device selected from the group consisting of: a portable hard drive, a flash drive, a hard drive, and wherein the memory device is connected to the display device.

8. An interactive display device as claimed in claim 1 wherein the information is stored on a remote server which is wirelessly connected to the display device.

9. An interactive display device as claimed in claim 1 further comprising a speaker through which information relating to the product within the housing may be played, and a volume control for adjusting the level of sound from the speaker.

10. An interactive display device as claimed in claim 1 wherein the power source is an AC power supply and includes a power adapter for modulating the AC power supply for use by the interactive display device.

11. An interactive display device as claimed in claim 1 wherein the power source is a battery.

12. An interactive display device as claimed in claim 11 wherein the battery is rechargeable while located in the interactive display device.

13. An interactive display device as claimed in claim 11 wherein the battery can be removed and recharged.

14. An interactive display device as claimed in claim 11 wherein the battery power consumption level remains at or above a threshold for operation and response to sensor input.

15. An interactive display device as claimed in claim 1 wherein each compartment has a corresponding file containing information relating to the product in that compartment.

16. An interactive display device as claimed in claim 15 wherein the product in a compartment may be selectively removed and replaced another, along with the corresponding file containing information relating to the product in that compartment.

17. An interactive display device as claimed in claim 1 wherein the housing is mounted on a base such that the housing is rotatable on the base.

18. An interactive display device as claimed in claim 1 wherein the housing comprises receiving spaces for receiving and holding the display device and other promotional materials.

19. An interactive display device as claimed in claim 1 wherein:
the housing comprises a pair of opposing vertical compartments separated by a central space therebetween;
the display device comprises a monitor mounted on a shaft;
illumination means are located on the shaft; and
wherein the shaft is accommodated in the central space and the display device is located on an external surface of the housing such that the illumination means provide light to the compartments.

20. An interactive display device comprising: a display device having sections for accommodating one or more products; and a control center for receiving and presenting information relating to a selected product contained within the display device, the control center being connectable to a medium whereby information relating to a product is stored.

21. An interactive display device as claimed in claim 20 wherein different products can be removed and replaced within one or more sections in the display device, and information relating to products currently contained within the display device can be associated with or downloaded to the control center.

22. A method of displaying one or more products, the method comprising placing the products in a designated section of a display device, and providing various levels of information regarding the product in the display device when selected by a viewer.
